(19) United States
(12) Patent Application Publication
(10) Pub. No.: US 2023/0109462 A1
(43) Pub. Date: Apr. 6, 2023

(54) Dual Plectrum Guitar Pick

(71) Applicant: Jeffery Williams, Puyallup, WA (US)

(72) Inventor: Jeffery Williams, Puyallup, WA (US)

(21) Appl. No.: 17/492,582

(22) Filed: Oct. 2, 2021

(51) Int. Cl. G10D 3/173

(52) U.S. Cl. CPC G10D 3/173

(57) ABSTRACT

A pick providing two plectra is a laminate of two conjoined planar components. A first component comprises rigid material providing at one end a grasping portion and at an opposite end a plectrum portion as a rounded point suitable for plucking. The second component comprises flexible material providing at one end an upper portion for joining to the first component and at the other end a plectrum portion as a rounded point suitable for strumming. The pick is grasped by a player at the grasping portion of the first component. By angling the attack of the pick, the player may then employ either the plectrum of the first component for picking strings or the plectrum of the second component for strumming strings.

### BACKGROUND OF THE INVENTION

### Field of the Invention

This invention relates to plectra for playing stringed musical instruments. More specifically, this invention relates to plectra for playing guitars and the like.

### Description of the Related Art

Stringed musical instruments such as guitars are played by plucking or strumming the instrument's strings. The principal accessory for plucking or strumming the strings is a plectrum or pick, generally comprised of suitably shaped rigid or semi-rigid material terminating in a point which may be somewhat rounded. Using the plectrum's point, the instrument's player displaces a string from its resting position. The string is then released to vibrate and produce a note.

There are two generally recognized distinct methods of employing such a plectrum, each producing notes in a different manner. One such method is plucking or arpeggiation, in which strings are plucked individually and separately, each plucking producing a distinguishable individual note. Such a method is employed to render a melodic sequence. Further, rapid repeated plucking is often used for trilling or tremolo, particularly common in music for specific instruments such as the mandolin. Skill in plucking is often recognized as virtuosity on an instrument.

A second generally recognized distinct method of using a plectrum is strumming, in which the plectrum is used to pass over a plurality of strings in one motion, causing the strummed strings to vibrate and produce their notes at the same time. This method is used to produce chords and sequences of harmonies. These two different methods of playing a stringed instrument demand plectra with distinct characteristics.

For plucking, preferred plectra are relatively rigid, enabling precision in individual note production with respect to both meter and volume, as is required in skillful arpeggiation. In contrast, for strumming more flexible plectra are preferred, a flexible plectrum passing more easily over a sequence of strings than one which is rigid. Because different types of plectra are required for these two methods of playing, in the prior art the standard practice of a player who practices both techniques has been to carry two picks, one rigid for plucking and one flexible for strumming. It is desirable that a single pick could provide two plectra, so that a musician could select a plectrum appropriate for a given method of playing.

In the related art, a number of articles are described that provide a plurality of plectra. Typical of these is U.S. Pat. No. 6,342,661 to Flamm, in which a single grasping member retains two picking members in separate but parallel planes. By way of this device, Flamm enables the user to pluck two separate strings simultaneously. Another line of related art, exemplified by U.S. Pat. No. 4,248,128 to Des Gaines, provides a plurality of picks in a closely packed array, whereby a single string is plucked several times in a single stroke of the device. Yet another line of art is exemplified by U.S. patent publication number 20050204893 by Luschniu, in which two or more plectra are connected with a connecting member, with an intended use of providing a plurality of plucks of strings at the same time with a single stroke. None of this art, however, meets the need to provide two selectable plectra of differing rigidities in a single article.

What is needed is a pick comprising two plectra, one rigid and adapted for picking and the other flexible and adapted for strumming. Further, what is needed is such a pick configured so that a player may quickly and easily shift from use of one plectrum to the other. Yet further, what is needed is such a pick that is rugged and easily fabricated.

### SUMMARY OF THE INVENTION

A pick providing two plectra is a laminate of two planar components. A first component comprises rigid material providing at one end a grasping portion and at an opposite end a plectrum portion as a rounded point. The second component comprises flexible material providing at one end an upper portion for joining to the first component and at the other end a plectrum portion as a rounded point. The second component conjoins the first component by adhering the surface of the upper portion of the second component to the first component at an area intermediate the grasping portion and the plectrum portion of the first component, the plectrum portion of the second component distending from the first component. In embodiments, intermediate the grasping portion and the plectrum portion of the first component is a recessed area configured to receive the upper portion of the second component. The pick is grasped by a player at the grasping portion of the first component. By angling the attack of the pick, the player may then employ either the plectrum of the first component for plucking strings or the plectrum of the second component for strumming strings.

### BRIEF DESCRIPTION OF THE DRAWINGS

Objects of the present invention as well as advantages, features and characteristics, in addition to methods of operation, function of related elements of structure, and the combination of parts and economies and methods of manufacture, will become apparent upon consideration of the following description and claims with reference to the accompanying drawings, all of which form a part of this specification, wherein like reference numerals designate corresponding parts in the various figures, and wherein:

FIG. 1 is a view of an embodiment showing the two planar components comprising the invention;

FIG. 2 is a front view of an embodiment of the invention, showing the upper portion of the component comprising the stumming plectrum conjoined with the component comprising the picking plectrum;

FIG. 3 is a rear view of an embodiment of the invention; and

FIG. 4 illustrates the relative angles of the plectra of the invention.

### DETAILED DESCRIPTION OF THE INVENTION

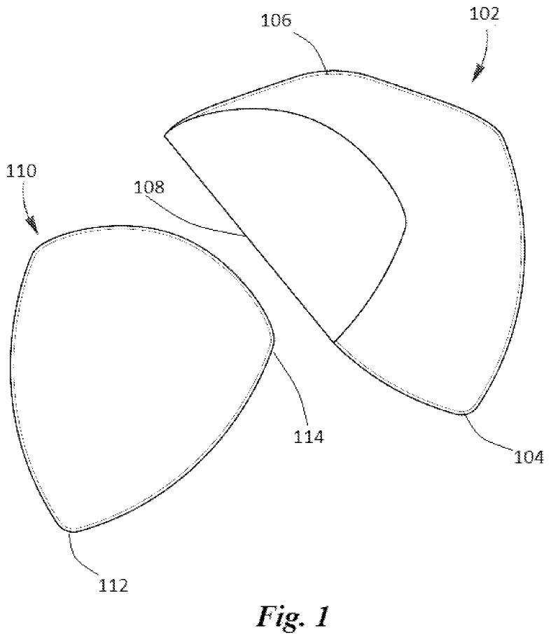

Turning now to the drawings, FIG. 1 depicts the two planar components comprising an embodiment of the invention. First component 102 is comprised of rigid material such as 0.73 mm polyetherimide, available as ULTEM® branded thermoplastic from Aetna Plastics Corp. of Valley View, Ohio. First component 102 is configured with a plectrum end 104 in the form of a rounded point and an opposite grasping end 106. In some embodiments such as that depicted here, first component 102 is further configured with a recessed area 108 for receiving second component 110. Second component 110 is comprised of flexible material such as 0.6 mm nylon. Second component 110 is configured with a plectrum end 112 and an upper portion 114 for conjoining to first component 102. In some embodiments, second component 110 may simply be along the lines of a smaller standard commercially available strumming type stringed instrument pick.

First component 102 may be fabricated by stamping its form into rigid sheet material. As will be understood by those in the art, alternative methods for fabricating the component include injection molding, additive manufacturing or machine tooling. Because of its relative thinness and uniform surface, in some embodiments the second component may be easily fabricated by simply punching the form from sheet material.

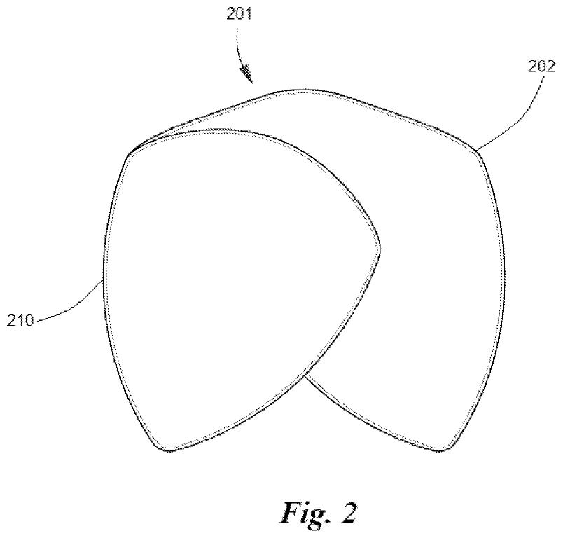

Turning now to FIG. 2, shown is a front view of an embodiment of a pick 201. Flexible second component 210 is conjoined with and affixed to rigid first component 202. In embodiments such as that depicted in FIG. 1, second component 210 is affixed within an appropriately configured recessed portion of first component 202. As will be understood by those in the art, embodiments may affix first component 202 and second component 210 together in a number of ways, including thermal bonding or by means of an adhesive glue such as acrylonitrile, epoxy or other permanent bonding agent.

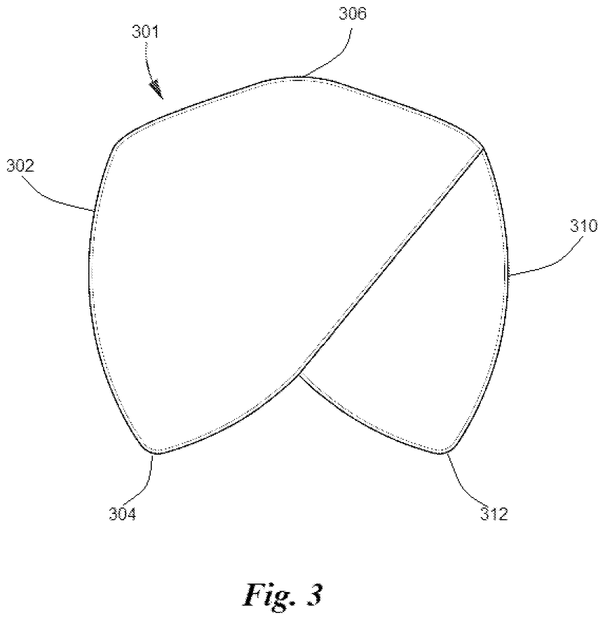

FIG. 3 is a rear view of an embodiment of the pick 301 such as depicted in FIG. 2. Rigid first component 302 retains flexible second component 310 in such a way that flexible plectrum 312 and rigid plectrum 304 depend from pick 301. A player grasps pick 301 at the grasping portion 306 of first component 302 of pick 301 and may selectively use either flexible plectrum 312 or rigid plectrum 304 by appropriately angling the attack of pick 301 to the strings of the player's instrument.

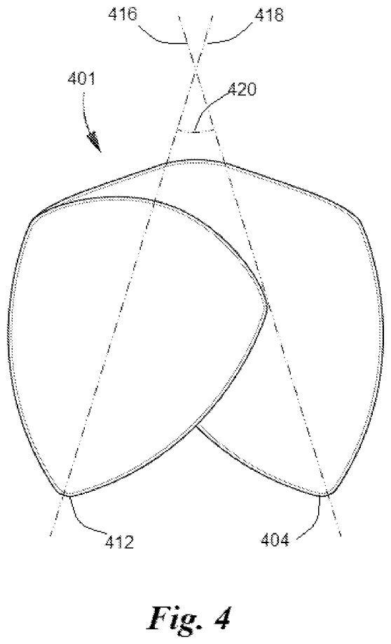

FIG. 4 is a front view of an embodiment of a pick 401 just as depicted in FIG. 2. First phantom line 416 and second phantom line 418 are normal to the curves of rigid plectrum 404 and flexible plectrum 412 respectively at their points. In the depicted embodiment, these phantom lines subtend an attack angle 420 of 36 degrees. This attack angle 420, the angle between rigid plectrum 404 and flexible plectrum 412, determines the displacement required for a player to adjust the attack of pick 401 between rigid plectrum 404 for plucking and flexible plectrum 412 for stumming. If attack angle 420 is too great, players will have difficulty quickly switching from one plectrum to the other. If attack angle 420 is too small, it may be difficult for the player to select a desired plectrum accurately. While 36 degrees has been found to be an effective attack angle, persons of skill in the art will recognize that picks may be fabricated in a range of attack angles around 36 degrees to provide the utility of the invention.

The invention accordingly affords the player of a stringed instrument the option of using a rigid plectrum for plucking or a flexible plectrum for strumming, with a design enabling ease of plectrum selection. Persons in the art will recognize that, while there is utility selecting an individual plectrum for playing, the invention may also serve to provide two plectra for picking one or more strings at once, producing a unique tone. In any case, it is notable that, though certainly appropriate for use with a guitar, the invention also provides utility for playing other stringed instruments such as mandolins, tenor banjos, lutes, balalaikas and so on.

The foregoing describes the invention with a certain degree of particularity. Nonetheless, it should be recognized that elements thereof may be altered by persons skilled in the art without departing from the spirit and scope of the invention. For example, while the rigid component of the invention has been described as substantially planar, embodiments may have 3-dimensional features for ergonomic, decorative or other purposes. Further, embodiments may vary the proportions and measurements of the invention's elements considerably from the depictions of embodiments in the drawings herewith while still practicing the invention. In any event, the present invention is not intended to be limited to the specific forms set forth in this specification, but on the contrary, it is intended to cover such alternatives, modifications and equivalents as can be reasonably included within the scope of the invention. The invention is limited only by the following claims and their equivalents.

1. A dual-plectrum pick for stringed instruments, comprising:
a rigid planar component, comprising:
a grasping portion,
a first plectrum distal the grasping portion, and
a receiving portion intermediate the grasping portion and the first plectrum;
a flexible planar component, comprising:
a lower portion comprising a second plectrum, and
an upper portion;
the upper portion of the flexible planar component affixed to the receiving portion of the rigid planar component,
whereby the dual-plectrum pick comprises the grasping portion and, distending therefrom, the first plectrum and the second plectrum.

2. The dual-plectrum pick for stringed instruments according to claim 1, wherein the first plectrum and the second plectrum subtend an angle between 25 and 45 degrees.

3. The dual-plectrum pick for stringed instruments according to claim 1, wherein the first plectrum and the second plectrum subtend an angle of 36 degrees.

4. The dual-plectrum pick for stringed instruments according to claim 1, wherein the rigid planar component is comprised of polyetherimide plastic.

5. The dual-plectrum pick for stringed instruments according to claim 1, wherein the flexible planar component is comprised of 0.5 to 0.8 mm sheet nylon.

6. A dual-plectrum pick for stringed instruments, comprising:
a rigid planar component comprised of polyetherimide plastic and further comprising:
a grasping portion,
a first plectrum distal the grasping portion, and
a receiving portion intermediate the grasping portion and the first plectrum;
a flexible planar component comprised of nylon and further comprising:
a lower portion comprising a second plectrum, and
an upper portion;
the upper portion of the flexible planar component affixed to the receiving portion of the rigid planar component,
whereby the dual-plectrum pick comprises the grasping portion and, distending therefrom, the first plectrum and the second plectrum.
